(19) United States
(12) Patent Application Publication
(10) Pub. No.: US 2024/0127610 A1
(43) Pub. Date: Apr. 18, 2024

(54) SYSTEM FOR BACTERIA, ALGAE AND/OR CYANOBACTERIA DETECTION

(71) Applicant: RAMBOLL AMERICAS ENGINEERING SOLUTIONS, INC., Syracuse, NY (US)

(72) Inventors: Igor Mrdjen, Liverpool, NY (US); Christopher Charles Nack, Cazenovia, NY (US); Zacharias John Tarr Smith, Lawrence, KS (US); Edward Bryan Arndt, Franklin, TN (US)

(73) Assignee: RAMBOLL AMERICAS ENGINEERING SOLUTIONS, INC., Syracuse, NY (US)

(21) Appl. No.: 18/486,365

(22) Filed: Oct. 13, 2023

Related U.S. Application Data
(60) Provisional application No. 63/416,056, filed on Oct. 14, 2022.

(51) Int. Cl. G06V 20/69; G06Q 50/26; G06T 7/00; G06V 10/70

(52) U.S. Cl. CPC G06V 20/698; G06Q 50/26; G06T 7/0002; G06V 10/70; G06T 2207/10056; G06T 2207/20081; G06T 2207/30188; G06T 2207/30242

(57) ABSTRACT

An example system for bacteria, algae and/or bacteria detection is provided. The system includes a database configured to electronically store data. The data includes a detection model trained based on historical bacteria, algae and/or cyanobacteria identification and cell count data. The system includes a processing device in communication with the database. The processing device is configured to receive as input an electronic image of a water sample, electronically detect bacteria, algae and/or cyanobacteria in the electronic image, execute the detection model to identify an organism responsible for the detected bacteria, algae and/or cyanobacteria, and estimate a cell count of the responsible organism based on the electronic image.

### CROSS-REFERENCE TO RELATED APPLICATIONS

This application claims the benefit of a co-pending, commonly assigned U.S. Provisional Patent Application No. 63/416,056, which was filed on Oct. 14, 2022. The entire content of the foregoing provisional application is incorporated herein by reference.

### BACKGROUND

Harmful algal blooms (HABs) are a perennial threat to humans worldwide. Different types of algae can develop in both saltwater and freshwater environments. In freshwater environments, most HABs can be caused by cyanobacteria (e.g., Microcystis, Dolichospermum, or the like), which can produce toxins that can be harmful to the human health. (See, e.g., Dyble, J. et al., Microcystin Concentrations and Genetic Diversity of Microcystis in the Lower Great Lakes, Environmental Toxicology, Wiley Periodicals, Inc., DOI 10.1002/tox, Dec. 15, 2007; see also Melo, G. d. A. et al., Image classification of cyanobacteria Microcystis aeruginosa in raw water samples in Curitiba's region, 2020 IEEE 33^{rd} International Symposium on Computer-Based Medical Systems (CBMS), DOI 10.1109/CBMS49503.2020.00024, 2020). For example, one common type of toxin produced by cyanobacteria are microcystins, which are believed to contribute to liver cancer. As a result, detection of cyanobacterial (and/or microcystins produced by the cyanobacteria) in a freshwater environment can result in long beach closures and contamination of drinking water supplies. Similar situations can arise when algae and/or bacteria is detected in saltwater environments.

Traditional monitoring of algae grown in water environments generally includes a significant lag between sample collection, analysis, and regulator action. For example, traditional methods of algae detection can include collection of the sample at the site, transport of the sample to a laboratory, waiting on a technician to review and analyze the sample, and providing the results of the analysis to the appropriate party. Analysis in the laboratory setting necessitates a live sample and cannot be performed based on images of the site; as such, the analysis of the live sample in the laboratory typically requires a lengthy period of time to ensure accurate detection, counting and/or measurement of the cell count/colony. Therefore, such traditional methods can necessitate more than 5 days. By the time results of the sample analysis are received, algae blooms can worsen, improve, and/or move. This can create continued over- or under-estimation of risk. Individuals responsible for decision-making based on the sample analysis typically rely on results that may be outdated and/or inaccurate, creating actions that may not be appropriate based on the current status of the algae growth. In addition, human analysis of a live sample can lead to incorrect colony or organism labeling/identification, resulting in inaccurate estimation of organism identification and detection. These inaccuracies can result in losses in economic productivity and social value through inaccessibility of the public to natural water systems.

As an example, beaches are often opened or closed based on limited information from spot samples. The conditions of the water at the beach may change significantly over a short period of time after the sample has been collected based on weather changes, current, or other environmental conditions. For drinking water supplies, detection of algae growth can necessitate operation of toxin removal and treatment. If the algae sample analysis is inaccurate or outdated, the resulting toxin removal and treatment plans may not be appropriately selected to fully treat the ongoing problem. Alternatively, the requested toxin removal and removal plan may be excessive given the reduction of algae growth since the sample was obtained, resulting in unnecessary expenses for treatment of the water supply. As a result, the decisions made based on traditional algae detection methods may be inaccurate and/or unnecessary in view of the significant lag between sample collection and receiving analysis results.

### SUMMARY

In accordance with embodiments of the present disclosure, an exemplary system for bacteria, algae and/or cyanobacteria detection is provided. In some embodiments, the system can be used for bacteria, algae and/or cyanobacterial bloom detection; in such instances, any reference to bacteria/bacterial blooms refers to cyanobacterial blooms. In some embodiments, the system can be used for algae, fungi, protozoa, and/or bacteria detection in which the bacteria can be any type of bacteria, including bacteria with and/or without blooms. For example, in some embodiments, the system can be used to detect organisms that cause brown and red tide algae, such as Karenia brevis, various diatoms, and macroscopic invertebrates. In some embodiments, the system can be used to detect any microscopic organisms.

The system includes a database configured to electronically store data. The data includes a detection model trained based on historical bacteria, algae and/or cyanobacteria identification and cell count data. The system includes a processing device in communication with the database. The processing device is configured to receive as input an electronic image of a water sample, electronically detect bacteria, algae and/or cyanobacteria in the electronic image, execute the detection model to identify an organism responsible for the detected bacteria, algae and/or cyanobacteria, and estimate a cell count and cell concentration of the responsible organism based on the electronic image. The system can be a machine learning and/or artificial intelligence system that is trained to detect organisms, demarcate identified colonies, and accurately estimate cell counts. The machine learning and/or artificial intelligence aspect of the system allows for accurate and consistent detection, identification and estimation of organisms/cell count in the sample using images of the sample, rather than relying on live samples and extended time for transport and analysis by a trained professional. The system performs consistently accurate identification and detection of cell types and counts without the typical error rates encountered by live sample analysis. In some embodiments, the input electronic image can be uploaded to a cloud-based storage and the model (also stored on the cloud-based storage) can process the image to identify the responsible organism and associated cell count. The bloom is at least one of an algae bloom or a bacterial bloom (e.g., a cyanobacterial bloom, or the like). The detection by the system can therefore be either algal, bacterial, or both, and can detect each with and/or without blooms.

In some embodiments, the type of cyanobacteria can be a cyanobacterial bloom. In some embodiments, the processing device can be configured to determine a genus of the cyanobacterial communities making up the bloom based on the electronic image. The processing device can be configured to determine a species of the genus. The processing device can be configured to perform an enumeration of cells based on colony shape and size to estimate the cell count and cell volume (e.g., cell concertation) of the responsible organism. In some embodiments, the model can apply an estimate of cell counts based on the colony shape and size by using the total number of pixels falling within a region detected to include the cyanobacterial and/or algae colony, and estimating the cell count based on the correlation of the total number of pixels falling within the region and previous pixel-to-cell count values.

In some embodiments, the processing device can be configured to receive as input environmental data and further configured to generate an estimation of future bloom cell count based on lack of remediation of the detected bloom. In some embodiments, the environmental data can include weather data, water quality data (temperature, turbidity, or the like), toxin concentration, genetic testing results (DNA concentrations, RNA concentrations, or the like), or combinations thereof. In some embodiments, the processing device can be configured to generate a likelihood of a bloom event based on historical data and the environmental data.

In some embodiments, the processing device can be configured to receive as input the electronic image of the water sample from a digital and/or traditional microscope. In some embodiments, the processing device can be configured to receive as input the electronic image of the water sample from a smart mobile device. In some embodiments, the processing device can be configured to receive as input the electronic image of the water sample from a camera configured to capture and transmit a new electronic image of additional water samples at a predetermined time interval. In such embodiments, the processing device can be configured to analyze the new electronic image to determine an update on a status of the detected bacteria, algae and/or cyanobacteria and the cell count.

In some embodiments, the data can include bloom guidelines regarding toxin levels. In some embodiments, the processing device can be configured to compare the cell count to the bloom guidelines and generate a report indicating whether remediation and/or intervention is recommended. In some embodiments, the processing device can be configured to generate a confidence level of the identified type of bacteria, algae and/or cyanobacteria and the estimated cell count of the detected bacteria, algae and/or cyanobacteria. In such embodiments, if the confidence level is below a threshold value, the processing device can be configured to generate a review request of at least one of the identified type of bloom or the estimated cell count. The feedback for the review request input into the database can be used by the system to further train the bloom detection model.

In accordance with embodiments of the present disclosure, an exemplary method for bacteria, algae and/or cyanobacteria detection is provided. The method includes receiving as input to a system for bacteria, algae and/or cyanobacteria detection an electronic image of a water sample. The system for bacteria, algae and/or cyanobacteria detection includes a database configured to electronically store data. The data can include a detection model trained based on historical bacteria, algae and/or cyanobacteria identification and cell count data. The system includes a processing device in communication with the database. The method includes electronically detecting bacteria, algae and/or cyanobacteria in the electronic image, executing the detection model to identify a type of bacteria, algae and/or cyanobacteria of the detected bacteria, algae and/or cyanobacteria, and estimating a cell count of the detected bacteria, algae and/or cyanobacteria based on the electronic image.

The method can include receiving as input environmental data including weather data, water quality data, toxin concentration, genetic testing results, or combinations thereof. The method can include estimating future bloom cell count based on lack of remediation of the detected bloom based on the input environmental data. In some embodiments, the method can include estimating or generating a likelihood of a bloom event based on historical data and the environmental data. The method can include receiving as input the electronic image of the water sample from a camera configured to capture and transmit a new electronic image of additional water samples at a predetermined time interval. The method can include analyzing the new electronic image to determine an update on a status of the detected bacteria, algae and/or cyanobacteria and the cell count.

In accordance with embodiments of the present disclosure, an exemplary non-transitory computer-readable medium storing instructions for bacteria, algae and/or cyanobacteria detection that are executable by a processing device is provided. Execution of the instructions by the processing device causes the processing device to receive as input to a system for bacteria, algae and/or cyanobacteria detection an electronic image of a water sample. The system for bacteria, algae and/or cyanobacteria detection includes a database configured to electronically store data. The data includes a detection model trained based on historical bacteria, algae and/or cyanobacteria identification and cell count data. The system includes a processing device in communication with the database. Execution of the instructions by the processing device causes the processing device to electronically detect bacteria, algae and/or cyanobacteria in the electronic image, execute the detection model to identify a type of bacteria, algae and/or cyanobacteria of the detected bacteria, algae and/or cyanobacteria, and estimate a cell count of the detected bacteria, algae and/or cyanobacteria based on the electronic image.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the system for bacteria, algae and/or cyanobacteria detection, reference is made to the accompanying figures, wherein:

FIG. 1 is a block diagram of an exemplary system for bacteria, algae and/or cyanobacteria detection in accordance with the present disclosure;

FIG. 2 is a block diagram of an exemplary computing device for implementing the exemplary system for bacteria, algae and/or cyanobacteria detection in accordance with the present disclosure;

FIG. 3 is a block diagram of an exemplary system for bacteria, algae and/or cyanobacteria detection environment in accordance with the present disclosure;

FIG. 4 is a flowchart of an exemplary process of implementing a system for bacteria, algae and/or cyanobacteria detection in accordance with the present disclosure;

FIG. 5 is a perspective view of an imaging device of an exemplary system for bacteria, algae and/or cyanobacteria detection in accordance with the present disclosure;

FIG. 6 is a view of a microscope image of a water sample analyzed by an exemplary system for bacteria, algae and/or cyanobacteria detection in accordance with the present disclosure;

FIG. 7 is a view of a microscope image of a water sample analyzed by an exemplary system for bacteria, algae and/or cyanobacteria detection in accordance with the present disclosure;

FIG. 8 is a view of a microscope image of a water sample analyzed by an exemplary system for bacteria, algae and/or cyanobacteria detection in accordance with the present disclosure;

FIG. 9 is a view of a microscope image of a water sample analyzed by an exemplary system for bacteria, algae and/or cyanobacteria detection in accordance with the present disclosure;

FIG. 10 is a graph of a Microcystis colony radius (size) determined by an exemplary bacteria, algae and/or cyanobacteria detection model as compared to a manual cell count with sonication;

FIG. 11 is a graph of a cyanobacterial density (in pixels) determined by an exemplary bacteria, algae and/or cyanobacteria detection model as compared to established lab analysis methods;

FIG. 12 is a user interface depicting tracing of colony borders and assigning identifications to detected colonies by an exemplary system for bacteria, algae and/or cyanobacteria detection in accordance with the present disclosure;

FIG. 13 is a user interface depicting tracing of colony borders and assigning identifications to detected colonies by an exemplary system for bacteria, algae and/or cyanobacteria detection in accordance with the present disclosure;

FIG. 14 is a user interface depicting tracing of colony borders and assigning identifications to detected colonies by an exemplary system for bacteria, algae and/or cyanobacteria detection in accordance with the present disclosure;

FIG. 15 is a user interface depicting tracing of colony borders and assigning identifications to detected colonies by an exemplary system for bacteria, algae and/or cyanobacteria detection in accordance with the present disclosure;

FIG. 16 is a user interface depicting recognition of colonies by their morphology by an exemplary system for bacteria, algae and/or cyanobacteria detection in accordance with the present disclosure;

FIG. 17 is a user interface depicting drawing of a mask around colonies by tracing its border and applying mask within its border by an exemplary system for bacteria, algae and/or cyanobacteria detection in accordance with the present disclosure;

FIG. 18 is a user interface depicting an original image with identification of empty space of a colony by an exemplary system for bacteria, algae and/or cyanobacteria detection in accordance with the present disclosure;

FIG. 19 is a user interface depicting drawing of a second mask over empty space of a colony and assigning masks with identification by an exemplary system for bacteria, algae and/or cyanobacteria detection in accordance with the present disclosure;

FIG. 20 is a user interface of a haemocytometer for cell counting training of an exemplary system for bacteria, algae and/or cyanobacteria detection without sonication of cells in accordance with the present disclosure;

FIG. 21 is a user interface of a haemocytometer for cell counting training of an exemplary system for bacteria, algae and/or cyanobacteria detection with cells sonicated (i.e., colonies disrupted into single-cell form) in accordance with the present disclosure;

FIG. 22 is a user interface depicting calculation of a colony area by number of pixels and labeling of said colony by an exemplary system for bacteria, algae and/or cyanobacteria detection in accordance with the present disclosure;

FIG. 23 is a regression graph representing a spherical radius of each colony and an estimated number of cells for use by an exemplary system for bacteria, algae and/or cyanobacteria detection in accordance with the present disclosure; and

FIG. 24 is a user interface depicting generation of bounding boxes and confidence ratings by an exemplary system for bacteria, algae and/or cyanobacteria detection in accordance with the present disclosure.

### DETAILED DESCRIPTION

As used herein, the term “bloom” refers to a bloom caused by algae, bacteria, fungi, protozoa, or a combination thereof. The system discussed herein can therefore be used to detect any type of bloom in water environments. In some embodiments, the system can be specific to detection of cyanobacterial blooms. However, in some embodiments, the system can be expanded to detect cyanobacterial blooms and other bacterial blooms. In some embodiments, the term “bloom” can refer to target organisms and materials that include brown and red tide causing algae, such as, but not limited to, Karenia brevis, various diatoms, dinoflagellates, and macroscopic invertebrates.

Embodiments of the present disclosure provide an exemplary system for algae, fungi, protozoa and/or bacteria bloom detection. The system provides means for accurately and efficiently monitoring water environments (both saltwater and freshwater) for bloom formation, and improves the response to bloom growth by increasing the flexibility and speed in collecting and analyzing samples. Although discussed herein as being used for detection and analysis of cyanobacteria, it should be understood that the system can be used to detect other types of algae and/or bacteria in the sample and quantify the concentration (e.g., an estimate of the concentration) based on the input sample image. For example, the system could be used to detect organisms that cause brown and red tide algae, such as Karenia brevis, various diatoms, dinoflagellates and macroscopic invertebrates. In some embodiments, the system could be combined with differential stains and/or fluorescence techniques to identify and enumerate bacteria, such as E. coli. The system can be used to collect a sample in the field (e.g., via a field microscope) and electronically transmit images of the sample captured by, e.g., a smart mobile device, a camera, or the like, to the system. In some embodiments, the digital field microscope can be an ioLight® 2 mm microscope, or the like. In some embodiments, the imaging device can be a 1 mm microscope, or the like. The digital microscopic images can be transmitted to the system as input for detection and enumeration of cyanobacterial cells. Based on an artificial intelligence and/or computer vision detection model trained via historical data on a neural network, the system can analyze the image(s) received of the sample and can automatically detect the status of algae and/or bacteria bloom growth. The system can detect both the type of algae and/or bacteria in the sample and the concentration of the algae and/or bacteria in the sample. In some embodiments, the system can analyze the digital image to detect and enumerate cyanobacterial and algal cells, or colonies, starting from 100 pixels in size and up to the total pixel size of the image. The system can therefore detect the type of cell type, the colony size, and estimates the total cell count for both two-dimensional and three-dimensional colonies. The system can detect, differentiate, and enumerate seven (7) genera of cyanobacteria: Microcystis, Dolichospermum, Woronichinia, Limnoraphis, Aphanizomenon, Gleotrichia, and Planktothrix. However, it should be understood that the system can detect, differentiate and/or enumerate different types of bacteria, algae, and/or cyanobacteria. The results of the analysis can be electronically transmitted to a user device such that a decision regarding the water environment can be made. In some embodiments, the results of the analysis can be provided to the user in about 30 seconds or less. In some embodiments, the process of obtaining a sample, capturing images of the sample, uploading the images, and obtaining results from the system can be about 10 minutes or less, depending on the user. In some embodiments, the results of the analysis can be provided as a one-time event based on user input of sample images into the system. In some embodiments, the system can automatically generate requests for action to be taken to remediate potential harm to individuals, e.g., closure of a beach or a drinking water facility based on detected toxin levels. For example, based on the results generated by the model, the system can provide recommended actions and provide alerts based on local guidelines around blooms.

In some embodiments, image and/or video capture devices (e.g., cameras) can be used to continuously monitor a water environment and to continuously or intermittently electronically transmit images to the system to monitor the water environment for bloom growth in a real-time manner. In some embodiments, an aspiration apparatus can be used to collect water, pass the water sample through a chamber, and image the water sample with a microscope to continuously/intermittently or substantially continuously/intermittently analyze the water sample to provide a real-time (or substantially real-time) status of the water. For example, the sample images can be captured and transmitted to the system for analysis every 60 minutes, every 4 hours, every 12 hours, every 24 hours, or the like, to ensure that substantially real-time or up-to-date information is being collected and analyzed for accurate decision-making. The fast and accurate results of the analysis allow for more accurate decisions to be made with respect to different types of water environments, and can reduce unnecessary toxin removal and/or treatment in drinking water environments. The system therefore reduces water and inefficiency typically encountered in traditional bloom detection methods, and provides for an overall safer water environment.

The artificial intelligence algorithm can be used by the system to evaluate the types of cyanobacteria present in a HAB and whether there is the potential for toxin contamination based on the input sample image. Based on an estimate of concentration for potential toxin-producing cyanobacteria (as generated by the system from the sample image), the system can determine whether the presence of toxins may be expected. If an abundance of the toxin is suspected (e.g., the concentration of potential toxin-producing organisms is equal to or above a threshold value), the system can either automatically generate an event or can provide a recommendation to a user for generating an event based on the determination that a safety risk at a beach is present or that a toxin abatement system should be brought online in a drinking water facility. The system can therefore either generate an action to reduce the abundance of the toxin or can assist with decision making by other systems and/or individuals. The system thereby provides quick and easy sample, fast response times (e.g., under two hours), the ability for receiving and analyzing multiple daily samples, the lack of necessity to involve an expert analyst, and the ability to estimate cell counts based on the sample image, resulting in an overall more efficient and accurate system.

In some embodiments, the system can provide recommendations on remediation action that can be taken based on Environment Protection Agency (EPA) and/or local guidelines, e.g., Recommendations for Cyanobacteria and Cyanotoxin Monitoring in Recreational Waters—available at https://www.epa.gov/sites/default/files/2019-09/documents/recommend-cyano-rec-water-2019-update.pdf. In some embodiments, the system can provide alert levels to the user based on geographically appropriate standards. For example, in testing and providing alerts for a water sample from the state of New Jersey, the system can rely on standards provided by the New Jersey Department of Environment Protection, e.g., Cyanobacterial Harmful Algal Bloom (HAB) Freshwater Recreational Response Strategy—available at https://www.state.nj.us/dep/hab/download/HAB2021StrategyFinal.pdf.

In some embodiments, the system can assign specific levels for cell concentration detection and correlate such specific levels with alert levels. Non-limiting examples of cell concentration levels are discussed herein. For example, no detection of cell formation can be correlated to a minimal risk level with no action required. For a detected cell concentration of <5,000 cell/mL, a very low acute effect risk levels can be assigned and the system can recommend continued monitoring and additional sampling. In such instances, no alert can be advised, and toxin testing may be advised only if the detection is made on the tail-end of a previous bloom. For a detected cell concentration of 5,000-20,000 cell/mL, a low acute effect risk level can be assigned and certain individuals with high sensitivity can be advised to avoid the affected area. Toxin testing can be advised at this level. For a detected cell concentration of 20,000 to 100,000 cells/mL, a moderate acute effect risk level can be assigned and alerts can be triggered. Beaches can be closed for recreational use based on local guidance determined by location (e.g., guidelines of the geographic area in which the sample was taken and/or surrounding regions). Toxin testing can be advised. For a detected cell concentration of 100,000 to 10,000,000 cells/mL, a high acute effect risk level can be assigned. Beach closures, warnings and alerts can be employed based on all state guidance. Toxin testing can be advised. For a detected concentration of >10,000,000 cells/mL, a very high acute health effect risk level can be assigned. Beaches and water access can be closed. Recommendations for liming access near the water and surrounding area can be made. Continuous monitoring is recommended and toxin testing can be advised.

The system can provide an AI-powered microscopy solution to cyanobacterial monitoring. The system can be used to evaluate digital microscope photographs using an artificial intelligence algorithm or model taught to detect and quantify cyanobacteria in raw water samples based on historical data. Images submitted to the system can be uploaded via a mobile application (e.g., on a smart mobile device) and analyzed by the system to detect the type of algae/bacteria and estimate the concentration of algae/bacteria present. An electronic report based on the findings can be generated and electronically transmitted to one or more users in communication with the system. The report can provide information associated with instances of cyanobacterial detection and identification, as well as relative cyanobacterial counts.

For the purposes of a cyanobacterial counts, the model can produce relative cell counts based on pixel areas per photo and the average size of cells per each genus and/or species of cyanobacteria. For example, the computer vision program/AI model can be taught to recognize cyanobacterial, bacterial and algal cells via cell shape and/or colony morphology. Colonies can only be identified and labelled if they reach a certainty threshold which can be set and altered by the developer of the AI model. Upon recognition of a colony, the computer vision program can generate/draw a shape outline of the colony (e.g., a mask) and can classify it by genus and/or species. Based on the genus and/or species classification, a cell counting model can be applied using colony and/or cell shape and size (area in pixels) to calculate relative 3-dimensional colony volume. The estimated colony volume can be converted into a cells/mL count using a cell counting model. For example, the cell counting model can correlate cell pixel areas to laboratory determined manual cell counts by an expert using a hemocytometer and optical microscope method. The system can therefore estimate cell count/concentration from the input image. In some embodiments, cells can be measured and an average cell size in pixels can calculated, with such data being used to train the model to automatically detect and quantify the cell count/concentration of the algae/bacteria detected in the image. In some embodiments, the model can be used to estimate average cell counts taking into account sample size, field views, and/or volume analyzed. In some embodiments, the cell model can receive as input manual cell counts (e.g., following the World Health Organization (WHO) guidelines and/or peer reviewed methods) and can compare the estimated cell counts from the input sample image relative to the guideline data to ensure accuracy of the estimations output by the system.

A variety of historical images can be input into the system for training of the artificial intelligence model to detect and label cyanobacteria. For example, 15,000+ images can be collected, analyzed for cyanobacteria type and cell count, and input into the AI model to recognize cyanobacteria across seven different genera. In some embodiments, the system can detect cyanobacteria in the genera of Microcystis, Dolichospermum, Woronichinia, Limnoraphis, Gleotrichia, Aphanizomenon, Planktothrix, or the like. Upon detection and classification, the system can assign custom name and colony shape labels to each cyanobacterial colony detected. Using the colony identification and shape, the system can apply a custom cell count model (e.g., customized for each genus and/or species) to determine relative cell abundance of each genus and/or species. The system can output and display to the user an image of the labeled cell colonies, cell type detected, number of individual cells/colonies detected, and calculated cell counts in cells/mL. In some embodiments, the system can use generated cell classifications, counts, and/or user provided information (such as weather, water quality, or the like) to automatically generate a geolocated water-quality database.

As the system is used to analyze newly input images, such images and results can be used to further train the neural network model to improve the accuracy of future results. The mobile application user interface allows for direct upload of images to the system, allowing for instant or substantially instant or real-time algae/bacteria identification and cell counts to be provided to users. In some embodiments, the system could be provided as a subscription model service for end users for monitoring water quality at one or more locations. The user can use the system to collect water samples, upload images using a mobile software application, and have the samples analyzed by the AI automatically (e.g., in real time or substantially in real time). Although discussed generally as a “water” sample, it should be understood that such sample can be freshwater, sea water, drinking water, potable water, processed water, any type of water, or the like. In some embodiments, the sample can be provided in a medium or matrix other than water. The user can receive as output from the system an analysis report with cyanobacterial detections and identifications, as well as relative cell counts. All data generated by the system can be warehoused and electronically stored in a database for continued training of the AI model. The data generated by the system can be accompanied by additional environmental data, e.g., weather, geolocation, water quality (turbidity, water temperature, nutrient concentrations (phosphorus, nitrogen, or the like)), cyanobacterial/algal toxin concentrations (if tested), DNA testing (if performed), combinations thereof, or the like.

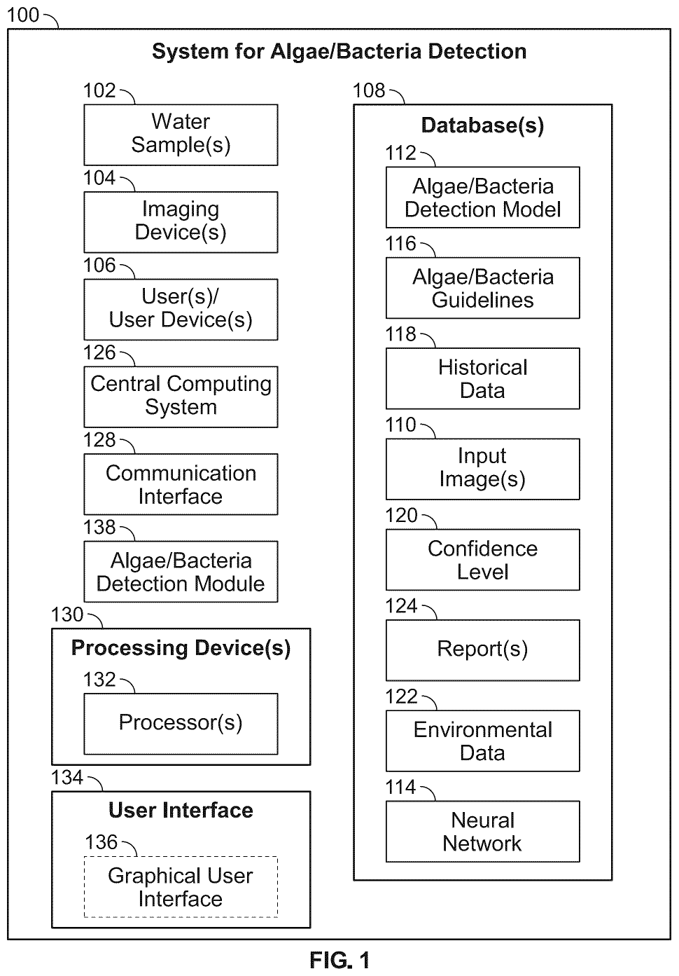

FIG. 1 is a block diagram of an exemplary system 100 for bacteria, algae, fungi, protozoa and/or cyanobacteria detection (hereinafter “system 100”). The system 100 generally includes one or more water samples 102 that can be collected at a water source. The water source can be a freshwater environment, a drinking water source, a seawater source, or the like. The sample 102 can be collected by a user via traditional means, and at least a portion of the sample 102 can be introduced into an imaging device 104, e.g., a field microscope. The imaging device 104 can be used to magnify the sample 102 and can capture one or more digital images/photographs that are electronically transmitted from the imaging device 104 to a user device 106, e.g., a smart mobile device, or the like. The user device 106 can be used to input the images into the system 100 as input images 110. In some embodiments, the imaging device 104 can automatically transmit the captured digital images to one or more databases 108 to electronically store the digital images as input images 110 to be analyzed by the system 100.

In some embodiments, the imaging device 104 can include one or more cameras that are configured to capture images of the water environment during predetermined time periods to continuously or substantially continuously monitor and analyze the images to determine if algae/bacteria is detected. In such embodiments, the captured images can be magnified by the imaging device 104 and/or a processing device of the system 100 such that the images can be used as input images 110 for analysis.

The one or more databases 108 of the system 100 can electronically store data associated with an algae/bacteria detection model 112 (e.g., an artificial intelligence, computer learning/vision algorithm, or the like) capable of receiving as input the images 110 and analyzing the images 110 to determine whether algae/bacteria is present, the type of algae/bacteria present, and estimate the concentration level of the algae/bacteria in the sample. In some embodiments, the model 112 can be associated with a neural network 114 to continuously improve or train based on analysis of the images 110. The database 108 can receive and store data associated with algae/bacteria guidelines 116 and historical data 118, both of which can be used to train the model 112. The guidelines 116 can be industry guidelines, such as the World Health Organization (WHO) guidelines regarding the types of algae/bacteria and concentration levels that can result in health concerns for humans. In some embodiments, the guidelines 116 can be automatically updated in real-time based on any changes to the industry guidelines, thereby allowing the model 112 to accurately identify algae/bacteria and provide recommendations on potential actions to be taken that are in-line with industry standards.

The historical data 118 can include images of previous samples 102 as captured by the imaging device 104, with user/reviewer interaction to identify the algae/bacteria types in the images and the concentration levels (e.g., cell count) of the algae/bacteria in the samples. For example, a laboratory technician can analyze the images under a microscope to confirm the specific algae/bacteria type present and the respective cell count. The model 112 can be trained based on these images to detect algae/bacteria within the images 110 receive from the field samples 102. The model 112 can use the historical data 118 to analyze input images 110 and identify the algae/bacteria type and cell count, and further uses the guidelines 116 to determine if the cell count is above a threshold value that could be problematic from a health perspective. In some embodiments, the model 112 can implement a colony equivalent spherical radius (ESR) calculation to estimate the cell count based on the sample images 110. The ESR can be calculated for each colony of algae/bacteria using pixels. Image acquisition and estimation of the cell counts form the images can be performed.

In some embodiments, the model 112 can generate a confidence level 120 after analysis of the image 110 has been completed. The confidence level 120 can be a value between 0-100% and can identify whether the system 100 believes the algae/bacteria type and cell count have been accurately determined. If, based on the historical data 118, the model 112 determines that the accuracy of the identification is questionable (e.g., if a new type of algae/bacteria is detected), the confidence level 120 can be below a threshold value (e.g., 90%, or the like). In such instances, the system 100 can flag the results and request that an external party, such as a laboratory technician, review the analysis to confirm the findings of the model 112. The laboratory technician feedback can be input into the system 100 to further train the model 112, ensuring that the AI model 112 continues to improve its detection abilities.

In some embodiments, the system 100 can store environmental data 122 associated with the specific sample images 110 being analyzed. For example, the environmental data 122 can include weather data, water quality data (temperature, turbidity, or the like), current data, geolocation, combinations thereof, or the like. Such data can assist in determining factors that may increase or decrease the cell count of the detected algae/bacteria, allowing for a more accurate prediction of a potential increase in the current status of the algae/bacteria growth. For example, if the environmental data 122 indicates that water or air temperatures are increasing in an area where the sample indicates algae/bacteria growth has occurred (e.g., expected high temperatures for the next week or two weeks), the model 112 can provide the user with information on the current status of the algae/bacteria detected (e.g., algae/bacteria type and cell count), but also generate a predicted algae/bacteria status (e.g., estimated cell count and additional algae/bacteria types) if action is not taken to remediate the situation within a predetermined period of time. The model 112 can provide the predictions or estimations based on a predetermined time period, or can provide predictions for multiple time periods, e.g., a week of no action, two weeks of no action, a month of no action, or the like. The model 112 (and system 100) can therefore provide predictive data that may be helpful for decision-makers to rely on in determining what action should be taken and how quickly.

In some embodiments, the predictive aspect of the system can be used to correlate historic environmental data (e.g., weather, water quality, or the like) with suspected bloom reports, bloom incidence, severity and causative organisms to determine the risk level of a bloom occurring in the future. For example, if a user uses the system on a lake for extended periods of time, historical data can be used to model patterns in bloom appearance. Based on the historical data, the system can model potential patterns of bloom appearance. As an example, every time a rainstorm occurs and it is followed by X sunny, calm days, and water temperature is above a modeled threshold, historically reports of blooms spike. Modeling of such patterns can be used to develop bloom risk calculations and bloom appearance patterns. Once this type of prediction is developed and stored in the system, the system can send alerts and bloom risk warnings to users alerting them to be on the lookout for bloom events in the future if similar conditions are met. The generated analysis and predictions data can be provided to the user via an electronic report 124 that can be transmitted to the user device 106, or individualized alerts, to allow the user to take action as needed.

The system 100 can include a central computing system 126 that is in communication with each of the user devices 106 and/or imaging devices 104 and the one or more databases 108 associated with the system 100 through a communication interface 128. The communication interface 128 is configured to provide for a communication network between components of the system 100, thereby allowing data to be electronically transmitted and/or received by the components of the system 100. The system 100 can include at least one processing device 130 with a processor 132 for receiving and processing the data stored in the system 100. The system 100 includes at least one user interface 134. In some embodiments, the user interface 134 can include a display in the form of a graphical user interface (GUI) 136. The GUI 136 can be a display incorporated into the user device 106 and/or the imaging device 104 to allow for users to communicate with each other and/or the system 100 via the communication interface 128. The system 100 includes an algae/bacteria detection module 138 that can be executed by the processing device 130 to implement the model 112 and analyze the images 110 received by the system 100. The module 138 can execute the model 112 and output the results (and optionally predictions) associated with the detected algae/bacteria and cell counts. In some embodiments, the module 138 can include multiple units or modules capable of being executed to perform respective steps of the detection, identification and estimation steps of the system 100 (e.g., a colony identification and classification model, a cell count estimation model, combinations thereof, or the like).

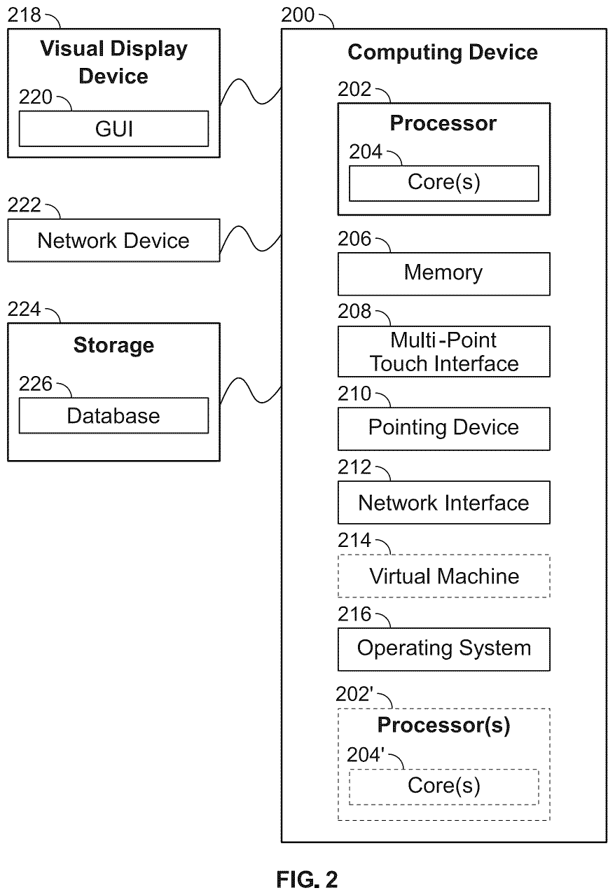

FIG. 2 is a block diagram of a computing device 200 in accordance with exemplary embodiments of the present disclosure. The computing device 200 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 206 included in the computing device 200 may store computer-readable and computer-executable instructions or software for implementing exemplary embodiments of the present disclosure (e.g., instructions for operating the algae/bacteria detection module, instructions for operating the algae/bacteria detection model, instructions for operating the processing device, instructions for operating the communication interface, instructions for operating the user interface, instructions for operating the central computing system, combinations thereof, or the like). The computing device 200 also includes configurable and/or programmable processor 202 and associated core 204, and optionally, one or more additional configurable and/or programmable processor(s) 202′ and associated core(s) 204′ (for example, in the case of computer systems having multiple processors/cores), for executing computer-readable and computer-executable instructions or software stored in the memory 206 and other programs for controlling system hardware. Processor 202 and processor(s) 202′ may each be a single core processor or multiple core (204 and 204′) processor.

Virtualization may be employed in the computing device 200 so that infrastructure and resources in the computing device 200 may be shared dynamically. A virtual machine 214 may be provided to handle a process running on multiple processors so that the process appears to be using only one computing resource rather than multiple computing resources. Multiple virtual machines may also be used with one processor. Memory 206 may include a computer system memory or random access memory, such as DRAM, SRAM, EDO RAM, and the like. Memory 206 may include other types of memory as well, or combinations thereof.

A user may interact with the computing device 200 through a visual display device 218 (e.g., a personal computer, a mobile smart device, or the like), such as a computer monitor, which may display at least one user interface 220 (e.g., a graphical user interface) that may be provided in accordance with exemplary embodiments. The computing device 200 may include other I/O devices for receiving input from a user, for example, a camera, a keyboard, microphone, a microscope, or any suitable multi-point touch interface 208, a pointing device 210 (e.g., a mouse). The keyboard 208 and the pointing device 210 may be coupled to the visual display device 218. The computing device 200 may include other suitable conventional I/O peripherals.

The computing device 200 may also include at least one storage device 224, such as a hard-drive, CD-ROM, eMMC (MultiMediaCard), SD (secure digital) card, flash drive, non-volatile storage media, or other computer readable media, for storing data and computer-readable instructions and/or software that implement exemplary embodiments of the system described herein. Exemplary storage device 224 may also store at least one database 226 for storing any suitable information required to implement exemplary embodiments. For example, exemplary storage device 224 can store at least one database 226 for storing information, such as data relating to the algae/bacteria detection model, algae/bacteria guidelines, historical data, input images, confidence level, reports, environmental data, neural network, combinations thereof, or the like, and computer-readable instructions and/or software that implement exemplary embodiments described herein. The databases 226 may be updated by manually or automatically at any suitable time to add, delete, and/or update one or more items in the databases.

The computing device 200 can include a network interface 212 configured to interface via at least one network device 222 with one or more networks, for example, a Local Area Network (LAN), a Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 212 may include a built-in network adapter, a network interface card, a PCMCIA network card, Pa Cl/PCIe network adapter, an SD adapter, a Bluetooth adapter, a card bus network adapter, a wireless network adapter, a USB network adapter, a modem or any other device suitable for interfacing the computing device 200 to any type of network capable of communication and performing the operations described herein. Moreover, the computing device 200 may be any computer system, such as a workstation, desktop computer, server, laptop, handheld computer, tablet computer (e.g., the tablet computer), mobile computing or communication device (e.g., the smart phone communication device), an embedded computing platform, or other form of computing or telecommunications device that is capable of communication and that has sufficient processor power and memory capacity to perform the operations described herein.

The computing device 200 may run any operating system 216, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 216 may be run in native mode or emulated mode. In an exemplary embodiment, the operating system 216 may be run on one or more cloud machine instances.

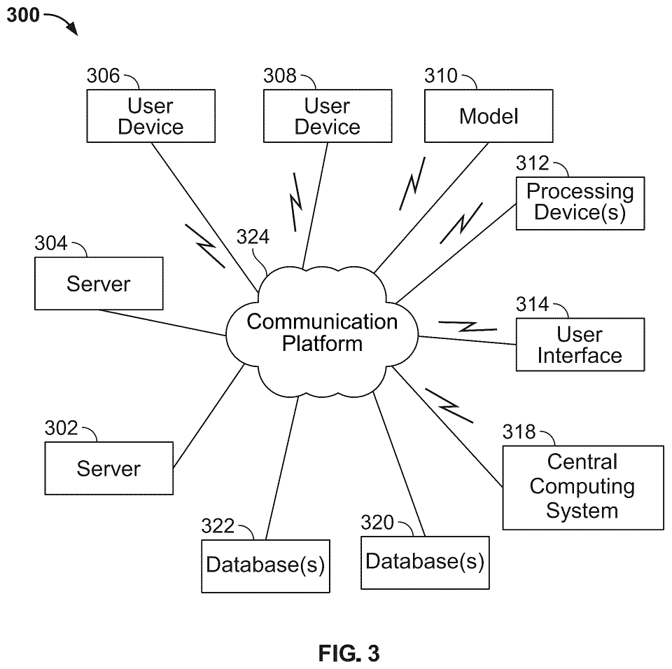

FIG. 3 is a block diagram of an exemplary system environment 300 for algae/bacteria detection in accordance with exemplary embodiments of the present disclosure. The environment 300 can include servers 302, 304 configured to be in communication with at least one user device 306, 308 (e.g., imaging device, smart mobile device, microscope, or the like), the model 310, at least one processing device 312, at least one user interface 314, and a central computing system 318 via a communication platform 324, which can be any network over which information can be transmitted between devices communicatively coupled to the network. For example, the communication platform 324 can be the Internet, Intranet, virtual private network (VPN), wide area network (WAN), local area network (LAN), and the like. In some embodiments, the communication platform 324 can be part of a cloud environment.

The environment 300 can include repositories or databases 320, 322, which can be in communication with the servers 302, 304, as well as the at least one user device 306, 308, the model 310, at least one processing device 312, at least one user interface 314, and the central computing system 318, via the communications platform 324. In exemplary embodiments, the servers 302, 304, at least one user device 306, 308, the model 310, at least one processing device 312, at least one user interface 314, and the central computing system 318 can be implemented as computing devices (e.g., computing device 200). Those skilled in the art will recognize that the databases 320, 322 can be incorporated into at least one of the servers 302, 304. In some embodiments, the databases 320, 322 can store data relating to the algae/bacteria detection model, algae/bacteria guidelines, historical data, input images, confidence level, reports, environmental data, neural network, combinations thereof, or the like, and such data can be distributed over multiple databases 320, 322.

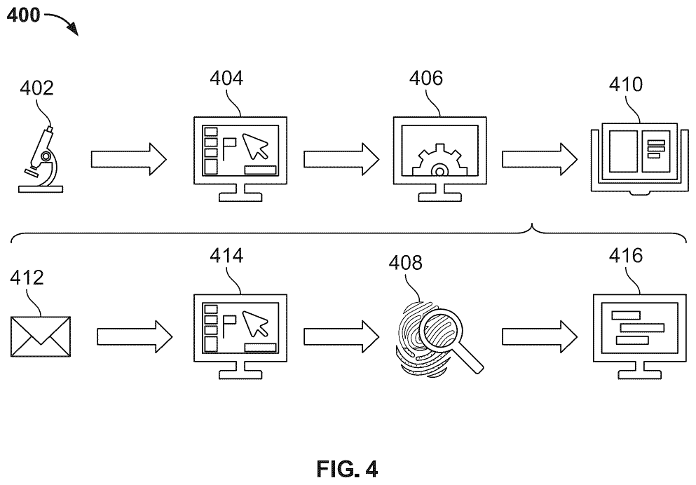

FIG. 4 is a flowchart of a process 400 for implementing the system 100. At step 402, one or more images of the sample are collected using a microscope in the field or in a laboratory setting. Using a smart mobile device or a computer, the user can log into the system at step 404 and can upload the captured images to the system at step 406. At step 408, the model associated with the system can receive as input the captured images and analyzes the images to detect whether algae/bacteria is present, identify the algae/bacteria type, and estimate the cell count. At step 410, the system outputs a report to the user with the results of the model detection/estimation.

In some embodiments, if the model detection/estimation is below a confidence level threshold value, the results of the detection/estimation can be confirmed by an external party. For example, at step 412, a laboratory technician associated with the system can receive a notification regarding a request for review and feedback. At step 414, the individual can log into the system and at step 408 performs the analysis of the sample images. At step 416, the individual can input the confirmation of the model detection/estimation or an adjustment of the model's findings as feedback into the system, and the updated results can be transmitted to the user at step 410. The feedback input into the system can be used to train the model to improve the accuracy of future detection/estimation.

Classification of Cell Type

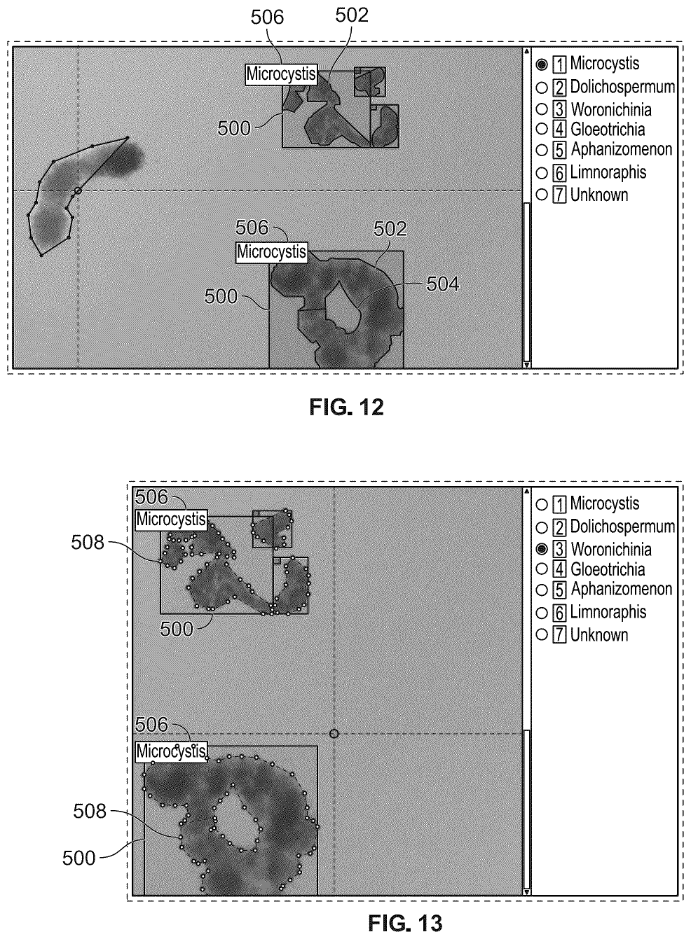

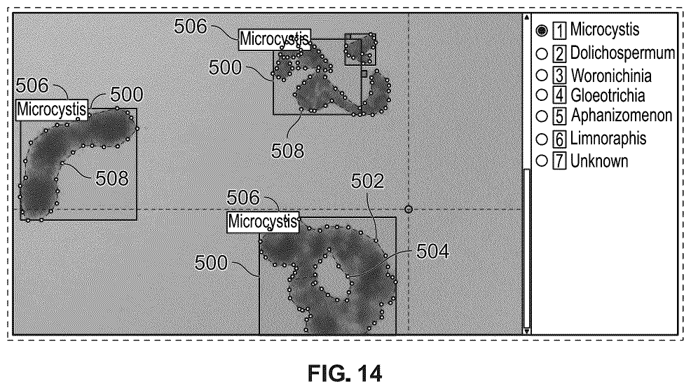

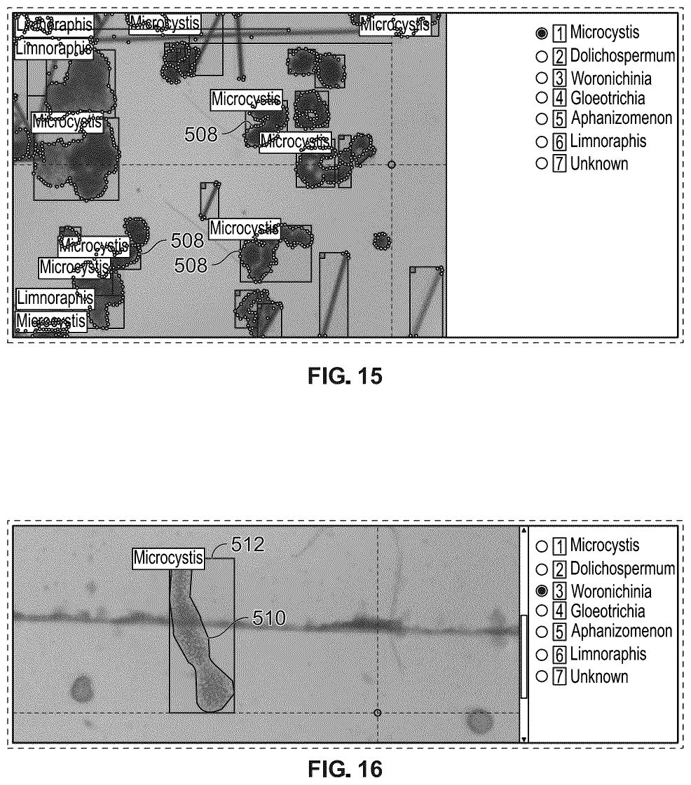

The system model was trained to identify and classify the cell type in each respective image (or groups of images). For example, in some embodiments, the model can be trained via the Microsoft Azure Machine Learning (Azure) suite. Over 20,000 microscopic images of cyanobacteria and algae were collected and archived in the system database using ioLight microscopes. The collected images were uploaded to the Azure blob storage (e.g., a database). Taxonomy experts accessed the photos and, using Azure's built-in image labeling tools, labeled each colony in each image for colony shape and identification. This process was performed by tracing each colony's border and assigning an identification for association with the traced colony. FIGS. 12-15 illustrate examples of a user interface with bounding boxes 500 for colonies, outer borders 502 (e.g., masks), empty space or inner borders 504 (e.g., masks), individual border points 508 that delineate the borders 502, 504, and colony labels 506 that identify the type of cell detected (in this instance Microcystis). Using this input data, the computer vision model mask (R-CNN) was fine-tuned and trained to recognize cyanobacterial colonies by their visual features (e.g., morphology, color, combinations, thereof, or the like). The computer vision model was tested for accuracy and was found to correctly detect and classify cyanobacterial colonies based on their morphology at a significantly higher rate (as compared to manual classification by human taxonomists). The computer vision model was also chosen based on its ability to make pixel sharp predictions on detected objects. This made the counting step possible as the model relies on a precise area covered by bacteria. The counting step applies formulars linking the area covered and bacteria count. The formulars are fitted to each bacteria type, considering their individual shape and cluster shape. The model takes into account the colony shape, color, size, and/or distinguishing features (such as granularity, cell sizes and negative space within the colonies). Following the training period, the computer vision model was deployed and housed on MS Azure. After training, the model was capable of receiving as input one or more images, and accurately detecting and classifying colonies in a substantially real-time manner. FIG. 16 illustrates a user interface with the model detecting a colony based on its morphology, and creating a mask or border 510 around the colony. The bounding box 512 creates a rectangular or square area that encompasses the entire colony.

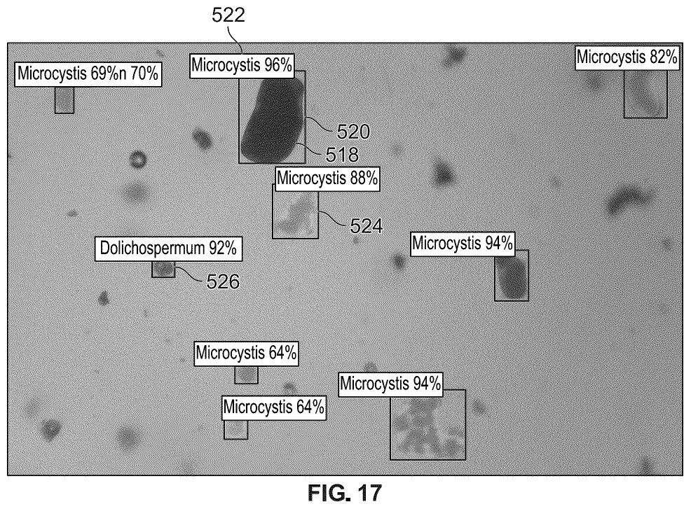

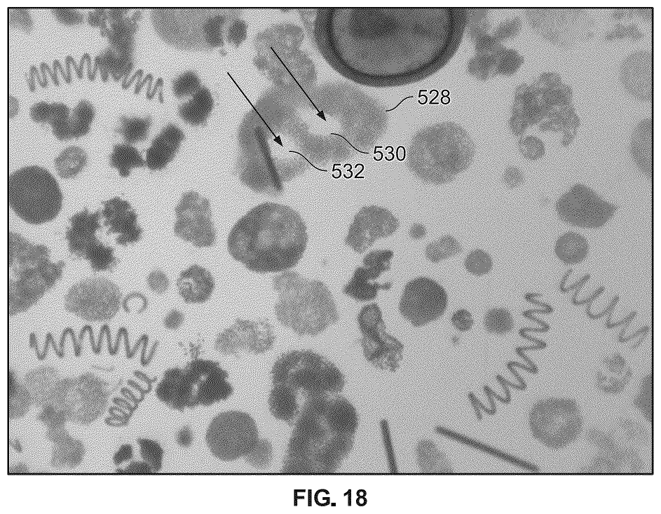

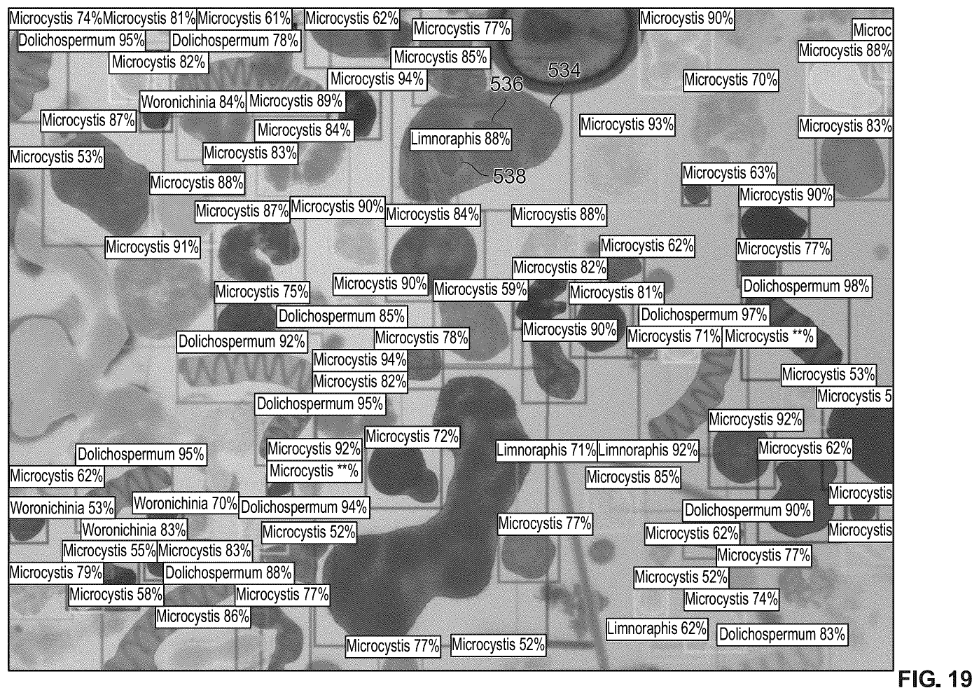

In operation, when a new image is uploaded to the system, the image is stored in the database. Meta data associated with the image (provided by the user's device) is also stored in the database. The images uploaded to the database are then processed by the computer vision model based on the previous training of the model. The model scans the image and detects the colony shape, size and/or distinguishing features based on previous training to identify the colony in the image. Upon recognizing a colony based on morphology and/or key characteristics, the model draws a “mask” around the colony (superimposed on the image) by tracing its border and applying a mask within its border. The mask is intended to create a border around the cells of the detected colony, such that all (or substantially all) cells are located within the border of the mask. FIG. 17 illustrates a user interface with a mask 518 generated around the colony, and a bounding box 520 encompassing the entire colony and mask 518. The bounding box 520 includes a label 522 with the name of the cell type and the confidence percentage. The system detects all cell types in the image and generates additional masks 524, 526 for each. If a colony has a negative space within the mask (e.g., empty space where no cells are present), the model can draw a second mask over the empty space. The model can subtract the negative space model from the positive space model to determine the mask that accurately reflects the size of the colony. FIG. 18 illustrates an original image with multiple cell types, and identifies one colony 528 with empty spaces 530, 532 within the colony 528. FIG. 19 illustrates an outer mask 534 generated around the colony, and inner masks 536, 538 generated for the empty spaces within the colony. Multiple masks are generated for each type of cell detected, and identifications are provided with a confidence percentage. Once a mask is deployed, an endpoint of the colony identification and mask area is generated.

Each colony identification is also accompanied by a confidence percentage, denoting how confident the model is in the classification the system has assigned and/or how closely the classified colony resembles the provided identification in its library of learned/historical images. The confidence threshold value (or range) can be programmed and preset into the system, or can be adjusted by the end user. In some embodiments, the confidence threshold value can be about 70%, with any value including and above 70% indicating an identification of a specific colony classification, and any value below 70% indicating a failure to identify a specific colony classification. In particular, to avoid false positives, the model does not label any colony formation that falls below the 70% confidence rating. This endpoint, containing colony identification, masks, and confidence intervals, can be input into a second model developed to generate cell counts. The cell counting model receives as input the applied masks, converts them into surface areas, and applies a different cell count model according to the colony classification associated with each mask. In some embodiments, each of the colony identification and cell counting steps can be performed by the same model (e.g., by respective units within the model).

Cell Counting

Traditionally, cell counts for cyanobacterial colonies are obtained by disrupting colonies and separating their cells into individual cells (when using live samples). This is often performed via sonication and physical disruption of colonies to separate out cells. The separated cells are then placed onto a hemocytometer, a microscope slide containing a known volume of liquid split up into grids calibrated for size. To determine an approximate cell count, individual cells are counted within a predetermined number of grids of the microscope slide. A calculation is then applied to the average of cells across these grids to determine a representative cell concentration for the sample. The pitfalls of this traditional method are that it generally necessitates a significant amount of time to perform and is difficult to apply when a sample has more than one type of cyanobacteria within it. Specifically, on an individual cell level, most cyanobacteria look the same and it can be difficult to accurately identify and differentiate the specific cell type and count. Further, the mechanical separation of colonies can disrupt or destroy cells, leading to artificially lowered cell counts, resulting in inaccuracies in cell type identification and cell count. In some instances, a second type of cell count estimation can use colony sizes in one or two dimensions to estimate cell counts based on previous measurements. In such method, the length, width, or both, of a certain colony can be used to estimate the number of cells within that colony. However, this method often overlooks obscure colony shapes, empty spaces in the colony, non-standard formations, and overlapping colonies. This type of cell count estimation also typically necessitates pretreatment of the sample with a fixative agent, such as the addition of Lugol's solution, to prevent cell/colony degradation during evaluation. Thus, traditional methods of cell identification and cell count typically include a high rate of inaccuracies.

Instead of using hemocytometer counts, the exemplary system model uses colony shape(s) and identification(s) to calculate and output cell counts on a per genus basis. The system can handle cell counts for each different genus the model identifies and requires no pre-treatment nor alteration of the original sample to work. This ensures a more accurate identification and estimation as compared to traditional cell count methods.

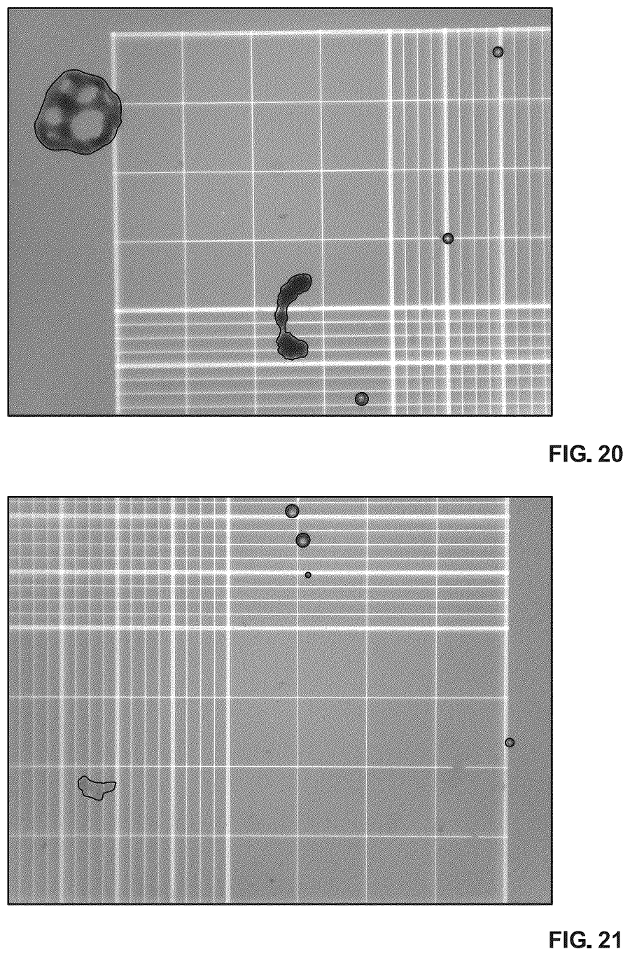

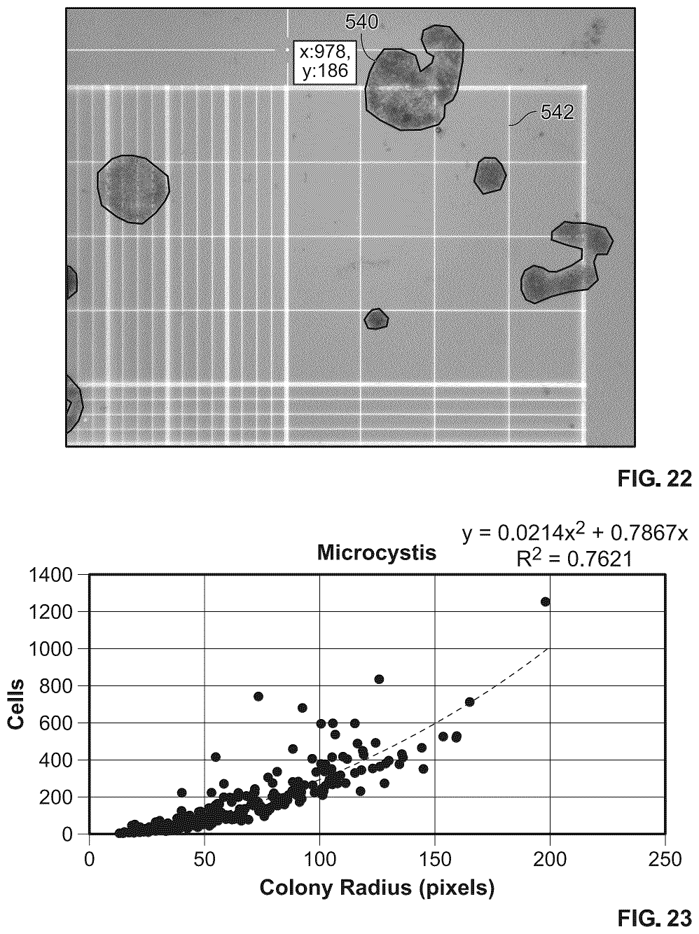

For experimentation of the system, cell counting models for Microcystis and Dolichospermum were developed by comparing colony size and shape to manual cell counts obtained by sonicating (busting up) the same colonies and counting individual cells via a hemocytometer and traditional microscopy. As illustrated in FIGS. 20 and 21, images were taken of samples dominant in Microcystis before and after sonication, and a hemocytometer was used to provide a fixed volume based on individual cells. Four images were taken of each slide and extrapolated for cells/mL. At least 100 Microcystis cells were counted per image. FIG. 22 shows a Microcystis colony 540 identified on a hemocytometer grid 542. The colony 540 area was calculated based on the number of pixels for each image via software labeling. The number of cells per colony were estimated based on the hemocytometer cell counts and the colony 540 area ratio. A regression was developed based on the equivalent spherical radius of each colony and the estimated number of cells, as illustrated in FIG. 23. The model was developed by assigning masks to colonies in samples and then correlating mask size and shape to manual cell counts via the hemocytometer and sonication method. The focal length of the microscope used to acquire the image was used to measure the visible volume in the photo. In particular, the focal length of the microscope allows for estimation of the volume of the identified colony from the two dimensional photograph/image input into the system. As such, the mask drawn by the system is used as a representation of the colony area and volume from the two dimensional image. Estimating the volume of a colony for cell count determination is typically difficult using manual methods, while the exemplary system allows for such volume determination accurately from the two dimensional image(s) input into the system.

The model uses the characteristics of each type of cell type for calculating the volume of the colony. For example, the model can rely on whether the colony formation is typically spherical or linear in shape to assist with estimation of the volume of the colony. The type of colony formation can be programmed into the model based on industry standards and/or data. In the case of Microcystis, the model integrates a volume figure into the cell counts by assuming a spherical volume ratio for each colony of likely spherical colonies. For example, models for Microcystis (which tend to be more spherical in colony formation) are assigned a higher cell count than those assigned to Dolichospermum (which tend to be more linear in shape/formation). This accounts for the three-dimensional nature of colonies (as compared to the traditional means of analyzing a two-dimensional image and calculating surface area). The result of the model therefore provides a more accurate estimation of the colony cell count as compared to traditional counting methods.

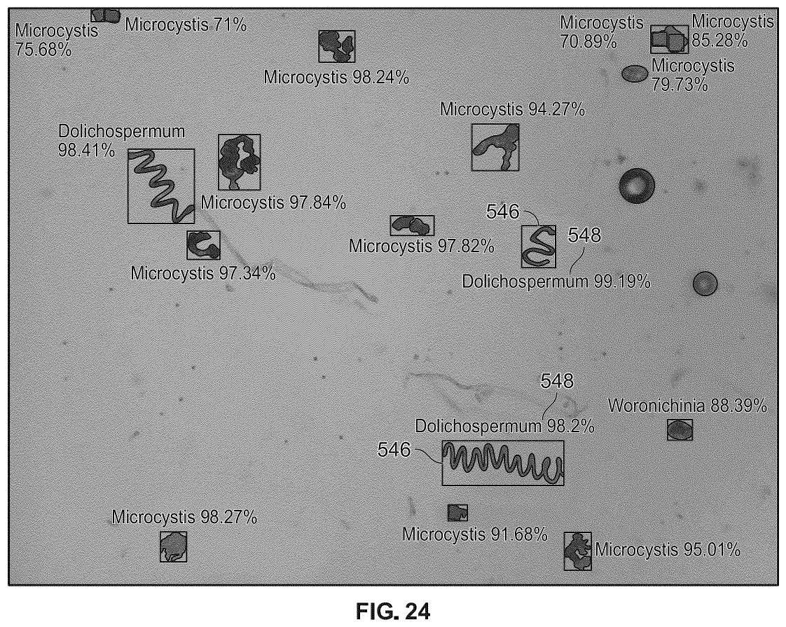

For the remaining colony types (e.g., Woronichinia, Aphanizomenon, Limnoraphis, and Gloeotrichia), the model can be programmed with custom cell count models based on values established in industry literature (such as government guidelines, methods papers and/or peer reviewed literature). These counts estimate a cell number per colony size. Therefore, the system rapidly measures each colony, correlates size to the established equivalent cell values, and determines an accurate cell count based on the two-dimensional image. Cell counts reported by the system for each colony can be added for a total cell count per genus (and per image). Cell counts are then averaged by the system across all images uploaded per sample and can be input into a third model (or used in the same model) to extrapolates cell count in the image(s) into cell counts/mL using volumes of sample imaged (via focal length and image size), volume of sample plated onto the slide, and conversion factors. The model can therefore extrapolate the cell count for the sample image(s) to the larger water volume to estimate the cell count for the entire water environment from which the sample image(s) was captured. The system can perform the colony identification and cell count estimation from the sample image for more than one type of cell, and performs such estimation accurately, allowing for substantially real-time results in an accurate and efficient manner. As an example, FIG. 24 illustrates a user interface with multiple bounding boxes 546 (for each identified bacteria) including identification information 548 (with confidence ratings or percentages) for a single image.

Following the application of the classification model and the establishment of assigned masks, the total area per genus is calculated for each image. Any masks labelling empty spaces within colonies are subtracted from the total area. The total mask area per genus is then inserted into the cell counting model, where the mask area is converted into total cell counts per genus (per photo/image). From here, the focal length of the microscope used for capturing of the image is used to establish the total volume represented by each image and the cell count associated with the calculated volume. A mathematical calculation is applied by the system to the established cell counts to extrapolate cell counts on a per photo basis to cells/mL. In some embodiments, ten photos can be analyzed per sample. However, in some embodiments, the user can upload any number of photos and the average is used for determination of the cell count and the extrapolation step. All final results of cell count are averages of all uploaded photos per sample. The system can therefore use two-dimensional images to determine the colony size (for each type of detected cell colony), the cell count for each colony, the average based on the cell count across all images, and the extrapolation in cells/mL for each genus.

The system can generate a report based on the determinations/estimations of the system. In some embodiments, the generated report can include, e.g., the number of colonies identified per genus (across photos uploaded), the average number of colonies per genus (across photos uploaded), the average cell/mL per genus in the sample photo set, the simplified bounding boxes around each colony (including genus classification and confidence rating for easy reference, combinations thereof, or the like. Bounding boxes can be derived from the classification mask of each colony, and can be electronically drawn to include the total expanse of each colony. The bounding box can include information regarding the estimations by the system, including, e.g., the identification and confidence rating of each mask in a simplified way. The bounding boxes can be overlaid on the image in the user interface of the user's device using the relative position of each box within each photo.

The artificial intelligence or machine learning aspect of the system can be continuously improved based on operation of the system. For example, feedback can be provided to the system to validate identification of colony sizes and/or cell counts, with the feedback being used by the system to optimize and improve future identifications and/or calculations. In some embodiments, to optimize and re-train the model, periodically, new images can be input into the training pipeline (as discussed above) and labeled by taxonomy experts. Images are then used to incorporate new masks, patterns and/or morphologies into the model's computer vision capabilities, thereby allowing the model to “learn” to see and identify new classes of cyanobacteria, algae, fungi, protozoa, combinations thereof, or the like.

Operation of the system can therefore include the following steps: the user logs into the application via the user interface, the user uploads images of the sample including metadata, images are stored in the database and metadata is stored with association to the images, the system sends a detection request to the model, the model receives as input the images from the database and performs the artificial intelligence analysis of the images, the model sends the detection results (including colony size, cell count, and genus information) to the user, and the results are displayed to the user via the user interface. Substantially real-time and accurate results of the sample results can therefore be provided to the user.

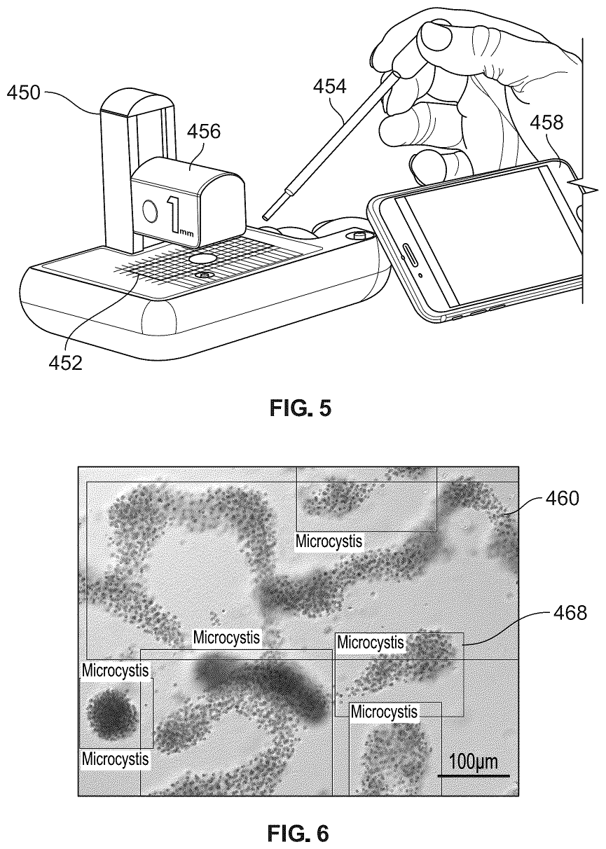

With reference to FIG. 5, a perspective view of an individual capturing images of a sample in the field is provided. The system includes a field microscope 450 that includes a platform 452 (e.g., a stage) capable of receiving a slide containing the water sample 454. An imaging portion 456 of the microscope 450 can be used to magnify the sample and transmit images of the magnified sample to either the system or to the user device 458. The user device 458 can be used to communicate with the system for analysis of the sample images and the output results. In some embodiments, rather than the microscope 450, the system can rely on one or more cameras that capture images of the water environment without human interaction, and the system is capable of internally magnifying and analyzing the captured images to detect algae/bacteria formation.

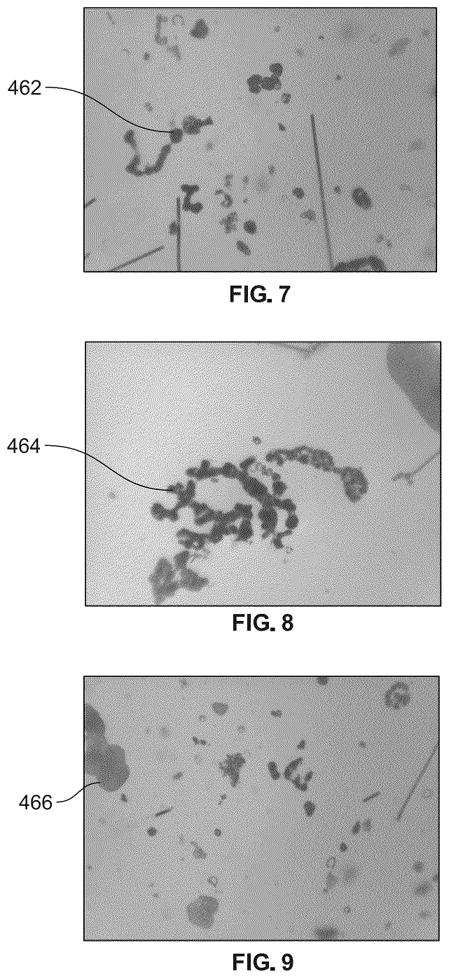

FIGS. 6-9 are microscope views of magnified water samples that depict the existence of algae/bacteria 460, 462, 464, 466. In some embodiments, the system can generate bounding boxes 468 around the detected algae/bacteria 460 to narrow the specific areas in which cell counts are to be performed. In some embodiments, the system can provide accurate results based on a single sample image input into the system. In some embodiments, the system can request input of additional images to provide a higher accuracy of detection and identification.

Operation of the exemplary algae/bacteria detection model was tested for accuracy by collecting over 15,000 samples and training the model. The samples were collected in areas with a high likelihood of containing cyanobacterial. Microscopes and kits were used to image and submit sample images to the system. Sample images were processed and analyzed via a cyanobacterial cell enumeration model. Image processing times were timed from receipt of data to final report submission. Images were processed for cyanobacterial identification and concentration determination. Lake water samples were used to compare the model results to an established method commonly used for HAB intensity measurements in a lab setting, i.e., FluoroProbe analysis. Twenty-six randomly selected samples were analyzed for BGA-Chi (an indicator of cyanobacterial pigment color and surrogate for cyanobacterial concentrations), cyanobacterial toxin concentrations, and cell identifications and counts. Model derived cyanobacterial concentrations were compared to FluoroProbe-derived BGA-Chi values as a means of comparing the model to established methods for measuring HAB intensity. The model used magnified images for algae/bacteria identification and used pixels of colonies to estimate the cell count. Samples were sonicated to break colonies into individual cells and cell counts were determined by hand using established hemocytometer methods. More than 290 unique data points were used in a comparison to evaluate the relationship between colony equivalent spherical radius (ESR) and individual cell counts.

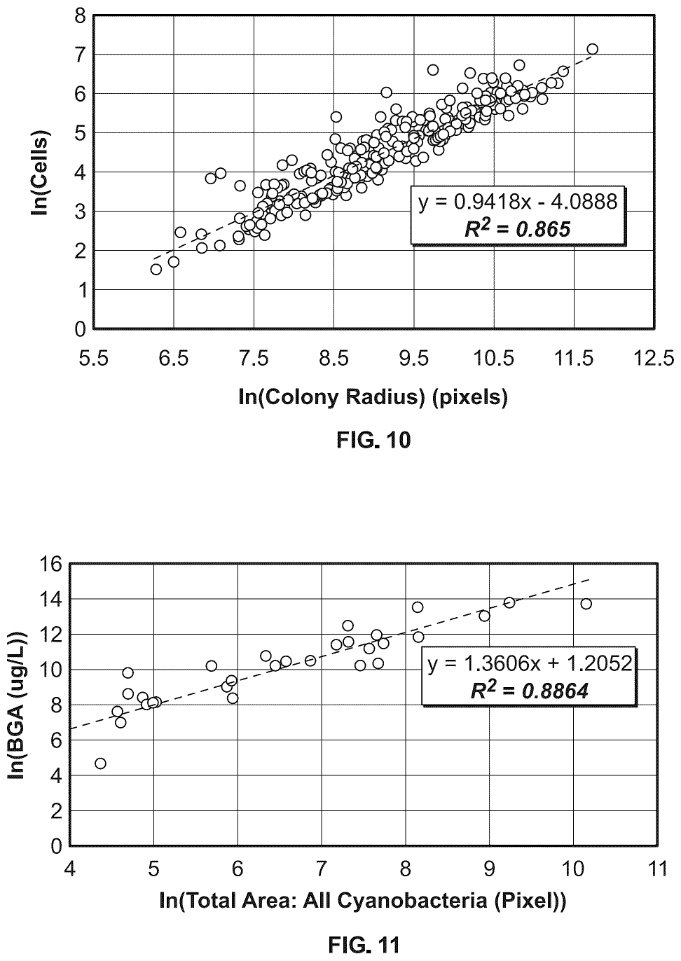

FIG. 10 is a graph of a Microcystis colony radius (size) determined by an exemplary algae/bacteria detection model as compared to a manual cell count with sonication. The R² value was calculated at about 0.865, demonstrating a linear relationship between the model determined relative colony volumes and traditional cell counting methodology. FIG. 11 is a graph of a cyanobacterial density (in pixels) determined by an exemplary algae/bacteria detection model as compared to established lab analysis methods. A substantially linear relationship (R² of 0.886) was established based on the FluoroProbe data and the model calculated total cyanobacterial pixel areas. Using the input images, the model can be trained to automatically recognize and enumerate cells within cyanobacterial colonies. The analysis results from the system can be received in an expedited manner as compared to traditional methods, and can provide for more accurate identification and quantification results based on a continuously improving AI model.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A system for bacteria, algae and/or cyanobacteria detection, comprising:
a database configured to electronically store data, the data including a detection model trained based on historical bacteria, algae and/or cyanobacteria identification and cell count data; and
a processing device in communication with the database, the processing device configured to:
receive as input an electronic image of a water sample;
electronically detect bacteria, algae and/or cyanobacteria in the electronic image;
execute the detection model to identify an organism responsible for the detected bacteria, algae and/or cyanobacteria; and
estimate a cell count of the responsible organism based on the electronic image.

2. The system of claim 1, wherein the cyanobacteria is a cyanobacterial bloom.

3. The system of claim 2, wherein the processing device is configured to determine a genus of the cyanobacteria communities making up the cyanobacterial bloom based on the electronic image.

4. The system of claim 3, wherein the processing device is configured to determine a species of the genus.

5. The system of claim 1, wherein the processing device is configured to perform an enumeration of cells based on colony shape and size to estimate the cell count and cell concentration of the responsible organism.

6. The system of claim 1, wherein the processing device is configured to receive as input environmental data and generate a likelihood of a bloom event based on historical data and the environmental data.

7. The system of claim 6, wherein the environmental data includes weather data, water quality data, toxin concentration, genetic testing results, or combinations thereof.

8. The system of claim 1, wherein the processing device is configured to receive as input the electronic image of the water sample from a digital and/or traditional microscope.

9. The system of claim 1, wherein the processing device is configured to receive as input the electronic image of the water sample from a smart mobile device.

10. The system of claim 1, wherein the processing device is configured to receive as input the electronic image of the water sample from a camera configured to capture and transmit a new electronic image of additional water samples at a predetermined time interval.

11. The system of claim 11, wherein the processing device is configured to analyze the new electronic image to determine an update on a status of the detected bacteria, algae and/or cyanobacteria and the cell count.

12. The system of claim 1, wherein the data include bloom guidelines regarding toxin levels.

13. The system of claim 12, wherein the processing device is configured to compare the cell count to the bloom guidelines and generate a report indicating whether remediation and/or intervention is recommended.

14. The system of claim 1, wherein the processing device is configured to generate a confidence level of the identified type of bacteria, algae and/or cyanobacteria and the estimated cell count of the detected bacteria, algae and/or cyanobacteria.

15. The system of claim 14, wherein if the confidence level is below a threshold value, the processing device is configured to generate a review request of at least one of the identified type of bacteria, algae and/or cyanobacteria or the estimated cell count.

16. A method for bacteria, algae and/or cyanobacteria detection, comprising:
receiving as input to a system for bacteria, algae and/or cyanobacteria detection an electronic image of a water sample, the system for bacteria, algae and/or cyanobacteria detection including (i) a database configured to electronically store data, the data including a detection model trained based on historical bacteria, algae and/or cyanobacteria identification and cell count data, and (ii) a processing device in communication with the database;
electronically detecting bacteria, algae and/or cyanobacteria in the electronic image;
executing the detection model to identify an organism responsible for the detected bacteria, algae and/or cyanobacteria; and
estimating a cell count of the responsible organism based on the electronic image.

17. The method of claim 16, comprising receiving as input environmental data including weather data, water quality data, toxin concentration, genetic testing results, or combinations thereof.

18. The method of claim 17, comprising predicting a likelihood of a bloom event based on historical data and the environmental data.

19. The method of claim 16, comprising receiving as input the electronic image of the water sample from a camera configured to capture and transmit a new electronic image of additional water samples at a predetermined time interval, and the method comprising analyzing the new electronic image to determine an update on a status of the detected bacteria, algae and/or cyanobacteria and the cell count.

20. A non-transitory computer-readable medium storing instructions for bacteria, algae and/or cyanobacteria detection that are executable by a processing device, wherein execution of the instructions by the processing device causes the processing device to:
receive as input to a system for bacteria, algae and/or cyanobacteria detection an electronic image of a water sample, the system for bacteria, algae and/or cyanobacteria detection including (i) a database configured to electronically store data, the data including a detection model trained based on historical bacteria, algae and/or cyanobacteria identification and cell count data, and (ii) the processing device in communication with the database;
electronically detect bacteria, algae and/or cyanobacteria in the electronic image;
execute the detection model to identify an organism responsible for the detected bacteria, algae and/or cyanobacteria; and
estimate a cell count of the responsible organism based on the electronic image.
